(19) United States
(12) Patent Application Publication
(10) Pub. No.: US 2025/0126656 A1
(43) Pub. Date: Apr. 17, 2025

(54) WIRELESS COMMUNICATION METHOD AND DEVICE THEREOF

(71) Applicant: ZTE CORPORATION, Shenzhen (CN)

(72) Inventors: Xiubin SHA, Shenzhen (CN); Bo DAI, Shenzhen (CN); He HUANG, Shenzhen (CN); Yuan GAO, Shenzhen (CN); Li NIU, Shenzhen (CN)

(73) Assignee: ZTE CORPORATION, Shenzhen (CN)

(21) Appl. No.: 18/985,326

(22) Filed: Dec. 18, 2024

Related U.S. Application Data
(63) Continuation of application No. PCT/CN2023/073408, filed on Jan. 20, 2023.

(51) Int. Cl. H04W 74/0833; H04W 48/20

(52) U.S. Cl. CPC H04W 74/0833; H04W 48/20

(57) ABSTRACT

A wireless communication method for use in a wireless terminal is disclosed. The method comprises receiving, from a wireless network node, a system information block of an anchor cell, wherein the system information block of the anchor cell comprises a radio resource configuration for at least one non-anchor cell; selecting the anchor cell or one of the at least one non-anchor cell based on the radio resource configuration; and performing a random access procedure in the selected cell.

### CROSS-REFERENCE TO RELATED PATENT APPLICATIONS

This application is a Continuation of PCT Application No. PCT/CN2023/073408, filed Jan. 20, 2023, incorporated herein by reference in its entirety.

### TECHNICAL FIELD

This document is directed generally to wireless communications, and in particular to 5G communications.

### BACKGROUND

Network energy saving is of great importance for environmental sustainability, to reduce environmental impact (greenhouse gas emissions) and save operational cost, and has become a key part of operation expense of network operators. In NR (new radio) networks, most of the energy consumption comes from the radio access network and in particular from Active Antenna Unit (AAU) or Remote Radio Unit (RRU), especially Power Amplifiers (PA).

### SUMMARY

Thus, how to reduce the power consumption of the radio access network needs to be discussed.

The present relates to methods, systems, and devices for SI (system information) configuration, and in particular to methods, systems, and devices for the SI configuration, PRACH (physical random access channel) resource selection and/or traffic carrier/cell determination.

The present disclosure relates to a wireless communication method for use in a wireless terminal. The method comprises:
receiving, from a wireless network node, a system information block of an anchor cell, wherein the system information block of the anchor cell comprises a radio resource configuration for at least one non-anchor cell,
selecting the anchor cell or one of the at least one non-anchor cell based on the radio resource configuration, and
performing a random access procedure in the selected cell.

Various embodiments may preferably implement the following features:

Preferably or in some embodiments, performing the random access procedure in the selected cell comprises:
transmitting, to the wireless network node, a random access preamble on the selected cell.

Preferably or in some embodiments, the radio resource configuration for a first non-anchor cell in the at least one non-anchor cell comprises at least one of: a physical cell identity of the first non-anchor cell, uplink frequency information of the first non-anchor cell, downlink frequency information of the first non-anchor cell, a physical random access channel (PRACH) resource configuration of the first non-anchor cell, a common search space configuration of the first non-anchor cell, a reference signal received power (RSRP) threshold of the first non-anchor cell, a weight or an indication for a random access process on the first non-anchor cell, or at least one downlink reference signal of the first non-anchor cell.

Preferably or in some embodiments, the anchor cell and a first non-anchor cell of the at least one non-anchor cell have the same physical cell identity if the radio resource configuration does not comprise a physical cell identity of the first non-anchor cell.

Preferably or in some embodiments, a first non-anchor cell in the at least one non-anchor cell shares at least one downlink reference signal with the anchor cell or a second non-anchor cell in the at least one non-anchor cell.

Preferably or in some embodiments, selecting the anchor cell or one of the at least one non-anchor cell based on the radio resource configuration comprises: selecting the anchor cell or one of the at least one non-anchor cell based on a weight of each of the anchor cell and the at least one non-anchor cell for the random access procedure.

Preferably or in some embodiments, wherein selecting the anchor cell or one of the at least one non-anchor cell based on the radio resource configuration comprises: selecting the anchor cell or the at least one non-anchor cell based on at least one of a first weight of the anchor cell for the random access procedure or a second weight of the at least one non-anchor cell for the random access procedure, and selecting one of the at least one non-anchor cell if the at least one non-anchor cell is selected.

Preferably or in some embodiments, the radio resource configuration comprises an indication of performing the random access procedure on the non-anchor cell, wherein selecting the anchor cell or one of the at least one non-anchor cell based on the radio resource configuration comprises: selecting one of the at least one non-anchor cell.

Preferably or in some embodiments, the radio resource configuration comprises an indication of performing the random access procedure on the anchor cell or the non-anchor cell, wherein selecting the anchor cell or one of the at least one non-anchor cell based on the radio resource configuration comprises: selecting the anchor cell or one of the at least one non-anchor cell.

Preferably or in some embodiments, a reference signal received power of the selected cell is greater than or equal to a reference signal received power threshold of the selected cell.

Preferably or in some embodiments, performing the random access procedure on the selected cell comprises:
transmitting, to the wireless network node in the selected cell, candidate cell information associated with at least one candidate cell,
receiving, from the wireless network node in the selected cell, mobility information associated with one of the at least one candidate cell, and
transmitting, to the wireless network node in the candidate cell associated with the mobility information, a radio resource control response message.

Preferably or in some embodiments, the candidate cell information associated with the at least one candidate cell is included in a Message 3 of the random access procedure.

Preferably or in some embodiments, the wireless communication method further comprises:
transmitting, to the wireless network node, a Message 3 of the random access procedure in the selected cell, and
receiving, from the wireless network node, a report indication for the candidate cell information.

Preferably or in some embodiments, the wireless communication method further comprises:
handing over to the candidate cell associated with the mobility information, or
adding the candidate cell associated with the mobility information as a secondary cell for a carrier aggregation or a dual connectivity.

Preferably or in some embodiments, the wireless communication method further comprises receiving, from the wireless network node in the candidate cell associated with the mobility information, system information for a radio resource control connected state.

Preferably or in some embodiments, performing the random access procedure in the selected cell comprises: transmitting, to the wireless network node in the selected cell, a capability indication of supporting the random access procedure in the non-anchor cell.

Preferably or in some embodiments, the capability indication is included in a Message 3, a Message 5 of the random access procedure, a user equipment capability information message or an uplink media access control control element.

Preferably or in some embodiments, performing the random access procedure in the selected cell further comprises:
receiving, from the wireless network node, a preamble configuration of a third non-anchor cell in the at least one non-anchor cell, and
transmitting, to the wireless network node in the third non-anchor cell, a random access preamble based on the preamble configuration.

Preferably or in some embodiments, the preamble configuration is received by or included in downlink configuration information or a radio resource control message.

Preferably or in some embodiments, the preamble configuration includes at least one of a cell identity of the third non-anchor cell, uplink frequency information of the third non-anchor cell or a preamble index.

The present disclosure relates to a wireless communication method for use in a wireless network node. The method comprises:
transmitting, to a wireless terminal, a system information block of an anchor cell, wherein the system information block of the anchor cell comprises a radio resource configuration for at least one non-anchor cell, and
performing, with the wireless terminal, a random access procedure in a cell selected from the anchor cell or one of the at least one non-anchor cell.

Various embodiments may preferably implement the following features:

Preferably or in some embodiments, performing, with the wireless terminal, the random access procedure on the cell selected from the anchor cell or one of the at least one non-anchor cell comprises:
receiving, from the wireless terminal, a random access preamble in the cell selected from the anchor cell or one of the at least one non-anchor cell.

Preferably or in some embodiments, the radio resource configuration for a first non-anchor cell in the at least one non-anchor cell comprises at least one of: a physical cell identity of the first non-anchor cell, uplink frequency information of the first non-anchor cell, downlink frequency information of the first non-anchor cell, a physical random access channel (PRACH) resource configuration of the first non-anchor cell, a common search space configuration of the first non-anchor cell, a reference signal received power (RSRP) threshold of the first non-anchor cell, a weight or an indication for a random access process on the first non-anchor cell, or at least one downlink reference signal of the first non-anchor cell.

Preferably or in some embodiments, the anchor cell and a first non-anchor cell of the at least one non-anchor cell have the same physical cell identity if the radio resource configuration does not comprise a physical cell identity of the first non-anchor cell.

Preferably or in some embodiments, a first non-anchor cell in the at least one non-anchor cell shares at least one downlink reference signal with the anchor cell or a second non-anchor cell in the at least one non-anchor cell.

Preferably or in some embodiments, performing, with the wireless terminal, the random access procedure in the selected cell comprises:
receiving, from the wireless terminal in the selected cell, candidate cell information associated with at least one candidate cell,
transmitting, to the wireless terminal in the selected cell, mobility information associated with one of the at least one candidate cell, and
receiving, from the wireless terminal in the candidate cell associated with the mobility information, a radio resource control response message.

Preferably or in some embodiments, the candidate cell information associated with the at least one candidate cell is included in a Message 3 of the random access procedure.

Preferably or in some embodiments, the wireless communication method further comprises:
receiving, from the wireless terminal, a Message 3 of the random access procedure in the selected cell, and
transmitting, to the wireless terminal, a report indication for the candidate cell information.

Preferably or in some embodiments, the wireless communication method further comprises: transmitting, to the wireless terminal in the candidate cell associated with the mobility information, system information for a radio resource control connected state.

Preferably or in some embodiments, performing, with the wireless terminal, the random access procedure in the selected cell comprises: receiving, from the wireless terminal, a capability indication of supporting the random access procedure in the non-anchor cell.

Preferably or in some embodiments, the capability indication is included in a Message 3, a Message 5 of the random access procedure, a user equipment capability information message or an uplink media access control control element.

Preferably or in some embodiments, performing, with the wireless terminal, the random access procedure in the selected cell further comprises:
transmitting, to the wireless terminal, a preamble configuration of a third non-anchor cell in the at least one non-anchor cell, and
receiving, from the wireless terminal in the third non-anchor cell, a random access preamble based on the preamble configuration.

Preferably or in some embodiments, the preamble configuration is transmitted by or included in downlink configuration information or a radio resource control message.

Preferably or in some embodiments, the preamble configuration includes at least one of a cell identity of the third non-anchor cell, uplink frequency information of the third non-anchor cell or a preamble index.

The present disclosure relates to a wireless communication method for use in a wireless terminal. The method comprising:
receiving, from a wireless network node, a first system information block of a serving cell, wherein the first system information block of the serving cell comprises a second system information block for at least one neighbor cell.

Various embodiments may preferably implement the following features:

Preferably or in some embodiments, the wireless communication method further comprises: performing an operation based on the a second system information block.

Preferably or in some embodiments, the first system information block comprises the second system information block by comprising at least one of:
a shared indication of common system information shared by the serving cell and the at least one neighbor cell, or
a delta indication of at least one difference between divergent system information in the first system information block and the divergent system information in the second system information block.

The present disclosure relates to a wireless communication method for use in a wireless network node. The method comprises:
transmitting, to a wireless terminal, a first system information block of a serving cell, wherein the first system information block of the serving cell comprises a second system information block for at least one neighbor cell.

Various embodiments may preferably implement the following feature:

Preferably or in some embodiments, the first system information block comprises the second system information block by comprising at least one of:
a shared indication of common system information shared by the serving cell and the at least one neighbor cell, or
a delta indication of at least one difference between divergent system information in the first system information block and the divergent system information in the second system information block.

The present disclosure relates to a wireless communication method for use in a wireless terminal. The method comprises:
receiving, from a wireless network node, a system information block associated with a plurality of paging bandwidth parts (BWPs) comprising an initial paging BWP and at least one additional paging BWP,
transmitting, to a wireless network node, a capability indication of supporting monitoring a paging message on the additional paging BWP, and
monitoring the paging message on one of the plurality of paging BWPs based on the system information block.

Various embodiments may preferably implement the following features:

Preferably or in some embodiments, the system information block associated with the plurality of paging BWPs comprises at least one of: a physical control channel configuration for each paging BWP, a paging BWP selection weight for each paging BWP, or a paging BWP selection indication.

Preferably or in some embodiments, monitoring the paging message on one of the plurality of paging BWPs based on the system information block comprises:
selecting a first paging BWP in the plurality of paging BWPs based on the system information block comprising a paging BWP selection weight for each paging BWP, and
monitoring the paging message on the first paging BWP,
wherein first paging BWP is a BWP having a smallest index n fulfilling:

$$floor ( UE\_ID / ( N * Ns ) ) mod W < W ( 0 ) + W ( 1 ) + … + W ( n )$$

where: W(i) is a paging BWP selection weight of the paging BWP with the index i, W is a total weight of the paging BWP selection weights for the plurality of BWPs, N is a number of total paging frames in a period, Ns is a number of paging occasions for a paging frame, and UE_ID is a remainder of dividing an identifier of the wireless terminal by an integer X.

Preferably or in some embodiments, monitoring the paging message on one of the plurality of paging BWPs based on the system information block comprises:
selecting a second paging BWP in the plurality of paging BWPs based on the system information block comprising an initial paging BWP selection weight for the initial paging BWP and an additional paging BWP selection weight for all of the at least one additional paging BWP, and
monitoring the paging message on the second paging BWP,
wherein:
the second paging BWP is the initial paging BWP if:
floor (UE_ID/(N*Ns*X))≤the initial paging BWP selection weight, or
UE_ID/(N*Ns*X)≤the initial paging BWP selection weight, or
the second paging BWP is one of the at least one additional paging BWP and an index of the second paging BWP is equal to floor (UE_ID/(N*Ns)) mod M,
where: N is a number of total paging frames in a period, Ns is a number of paging occasions for a paging frame, UE_ID is a remainder of dividing an identifier of the wireless terminal by an integer X, and M is a number of the at least one additional paging BWP.

Preferably or in some embodiments, monitoring the paging message on one of the plurality of paging BWPs based on the system information block comprises:
selecting a first additional paging BWP in the at least one the additional paging BWP based on the system information block comprising an additional paging BWP selection weight for all of the at least one additional paging BWP, and
monitoring the paging message on the first additional paging BWP,
wherein an index of the first additional paging BWP is equal to floor (UE_ID/(N*Ns)) mod M,
   where: N is a number of total paging frames in a period, Ns is a number of paging occasions for a paging frame, UE_ID is a remainder of dividing an identifier of the wireless terminal by an integer X, and M is a number of the at least one additional paging BWP.

Preferably or in some embodiments, monitoring the paging message on one of the plurality of paging BWPs based on the system information block comprises:
selecting a third paging BWP from the plurality of paging BWPs based on the system information block comprising a common paging BWP selection weight for all of the plurality of paging BWPs, and
monitoring the paging message on the third paging BWP,
wherein an index of the third paging BWP is floor (UE_ID/(N*Ns)) mod (M+1),
where: N is a number of total paging frames in a period, Ns is a number of paging occasions for a paging frame, UE_ID is a remainder of dividing an identifier of the wireless terminal by an integer X, and M is a number of the at least one additional paging BWP.

The present disclosure relates to a wireless communication method for use in a wireless network node. The method comprises:
transmitting, to a wireless terminal, a system information block associated with a plurality of paging bandwidth parts (BWPs) comprising an initial paging BWP and at least one additional paging BWP,
receiving, from the wireless terminal, a capability indication of supporting monitoring a paging message on the additional paging BWP, and
transmitting the paging message on one of the plurality of paging BWPs based on the system information block.

Various embodiments may preferably implement the following features:

Preferably or in some embodiments, the system information block associated with the plurality of paging BWPs comprises at least one of: a physical control channel configuration for each paging BWP, a paging BWP selection weight for each paging BWP, or a paging BWP selection indication.

Preferably or in some embodiments, transmitting, to the wireless terminal, the paging message on one of the plurality of paging BWPs based on the system information block comprises:
selecting a first paging BWP in the plurality of paging BWPs based on the system information block comprising a paging BWP selection weight for each paging BWP, and
transmitting, to the wireless terminal, the paging message on the first paging BWP,
wherein first paging BWP is a BWP having a smallest index n fulfilling:

$$floor ( UE\_ID / ( N * Ns ) ) mod W < W ( 0 ) + W ( 1 ) + … + W ( n )$$

where: W(i) is a paging BWP selection weight of the paging BWP with the index i, W is a total weight of the paging BWP selection weights for the plurality of BWPs, N is a number of total paging frames in a period, Ns is a number of paging occasions for a paging frame, and UE_ID is a remainder of dividing an identifier of the wireless terminal by an integer X.

Preferably or in some embodiments, transmitting, to the wireless terminal, the paging message on one of the plurality of paging BWPs based on the system information block comprises:
selecting a second paging BWP in the plurality of paging BWPs based on the system information block comprising an initial paging BWP selection weight for the initial paging BWP and an additional paging BWP selection weight for all of the at least one additional paging BWP, and
transmitting the paging message on the second paging BWP,
wherein:
the second paging BWP is the initial paging BWP if:
   floor (UE_ID/(N*Ns*X))≤the initial paging BWP selection weight, or
   UE_ID/(N*Ns*X)≤the initial paging BWP selection weight, or
the second paging BWP is one of the at least one additional paging BWP and an index of the second paging BWP is equal to floor (UE_ID/(N*Ns)) mod M,
   where: N is a number of total paging frames in a period, Ns is a number of paging occasions for a paging frame, UE_ID is a remainder of dividing an identifier of the wireless terminal by an integer X, and M is a number of the at least one additional paging BWP.

Preferably or in some embodiments, transmitting, to the wireless terminal, the paging message on one of the plurality of paging BWPs based on the system information block comprises:
selecting a first additional paging BWP in the at least one the additional paging BWP based on the system information block comprising an additional paging BWP selection weight for all of the at least one additional paging BWP, and
transmitting, to the wireless terminal, the paging message on the first additional paging BWP,
wherein an index of the first additional paging BWP is equal to floor (UE_ID/(N*Ns)) mod M,
   where: N is a number of total paging frames in a period, Ns is a number of paging occasions for a paging frame, UE_ID is a remainder of dividing an identifier of the wireless terminal by an integer X, and M is a number of the at least one additional paging BWP.

Preferably or in some embodiments, transmitting, to the wireless terminal, the paging message on one of the plurality of paging BWPs based on the system information block comprises:
selecting a third paging BWP from the plurality of paging BWPs based on the system information block comprising a common paging BWP selection weight for all of the plurality of paging BWPs, and
transmitting, to the wireless terminal, the paging message on the third paging BWP,
wherein an index of the third paging BWP is floor (UE_ID/(N*Ns)) mod (M+1),
   where: N is a number of total paging frames in a period, Ns is a number of paging occasions for a paging frame, UE_ID is a remainder of dividing an identifier of the wireless terminal by an integer X, and M is a number of the at least one additional paging BWP.

Preferably or in some embodiments, the wireless communication method further comprises:
transmitting, to an access and mobility management function, the capability indication of supporting monitoring the paging message on the additional paging BWP, and/or
receiving, from the access and mobility management function, the paging message of the wireless terminal, wherein the paging message comprises the capability indication of supporting monitoring the paging message on the additional paging BWP.

The present disclosure relates to a wireless communication method for use in a wireless terminal. The method comprises:
receiving, from a wireless network node, a system information block comprising physical random access channel (PRACH) information associated with a plurality of uplink bandwidth parts (BWPs) comprising an initial uplink BWP and at least one additional uplink BWP,
transmitting, to the wireless network node, a random access preamble on one of the plurality of uplink BWPs based on the system information block, and
monitoring a random access response on a downlink BWP corresponding to the uplink BWP on which the random access preamble is transmitted.

Various embodiments may preferably implement the following features:

Preferably or in some embodiments, the PRACH information for a first uplink BWP comprises at least one of: a PRACH configuration for the first uplink BWP, a PRACH BWP selection weight of the first uplink BWP, or a PRACH BWP selection indication of the initial uplink BWP and/or the at least one additional uplink BWP.

Preferably or in some embodiments, the PRACH configuration comprises at least one of: a PRACH resource, or a BWP identifier or an index of a corresponding downlink BWP configured to carry the random access response.

Preferably or in some embodiments, transmitting, to the wireless network node, the random access preamble on one of the plurality of uplink BWPs based on the system information block comprises:
selecting the initial uplink BWP or one of the at least one additional uplink BWP based on PRACH selection weights of the plurality of uplink BWPs, and
transmitting, to the wireless network node, the random access preamble on the selected uplink BWP.

Preferably or in some embodiments, transmitting, to the wireless network node, the random access preamble on one of the plurality of uplink BWPs based on the system information block comprises:
selecting the initial uplink BWP or the one additional uplink BWP based on at least one of an initial PRACH BWP selection weight of the initial uplink BWP or a common PRACH BWP selection weight for the at least one additional uplink BWP,
selecting one of the at least one at least one additional uplink BWP if the at least one additional uplink BWP is selected, and
transmitting, to the wireless network node, the random access preamble on the selected uplink BWP.

Preferably or in some embodiments, the PRACH information comprises a PRACH BWP selection indication of the at least one additional uplink BWP, and transmitting, to the wireless network node, the random access preamble on one of the plurality of uplink BWPs based on the system information block comprises:
selecting one of the at least one additional uplink BWP based on the PRACH BWP selection indication, and
transmitting, to the wireless network node, the random access preamble on the selected additional uplink BWP.

Preferably or in some embodiments, the PRACH information comprises a PRACH BWP selection indication of the initial uplink BWP and the at least one additional uplink BWP, and transmitting, to the wireless network node, the random access preamble on one of the plurality of uplink BWPs based on the system information block comprises:
selecting the initial uplink BWP or one of at least one additional uplink BWP based on the PRACH BWP selection indication, and
transmitting, to the wireless network node, the random access preamble on the selected uplink BWP.

Preferably or in some embodiments, a reference signal received power of the selected uplink BWP is greater than or equal to a reference signal received power threshold.

Preferably or in some embodiments, the wireless communication method further comprises transmitting, to the wireless network node in a second uplink BWP, a capability indication of supporting a random access procedure on the additional uplink BWP.

Preferably or in some embodiments, the capability indication is included in a Message 3, a Message 5, a user equipment capability information message or an uplink media access control control element.

Preferably or in some embodiments, transmitting, to the wireless network node, the random access preamble on one of the plurality of uplink BWPs based on the system information block, comprises:
receiving, from the wireless network node, a preamble configuration of a first additional uplink BWP in the at least one additional uplink BWP, and
transmitting, to the wireless network node in the first additional uplink BWP, the random access preamble based on the preamble indication.

Preferably or in some embodiments, the preamble configuration is received by or included in downlink control information or a radio resource control message.

Preferably or in some embodiments, the preamble configuration includes at least one of a BWP index of the first additional uplink BWP, uplink frequency information of PRACH resources for the first additional uplink BWP or a preamble index.

The present disclosure relates to a wireless communication method for use in a wireless network node. The method comprises:
transmitting, to a wireless terminal, a system information block comprising physical random access channel (PRACH) information associated with a plurality of uplink bandwidth parts (BWPs) comprising an initial uplink BWP and at least one additional uplink BWP,
receiving, from the wireless terminal, a random access preamble on one of the plurality of uplink BWPs, and
transmitting, a random access response on a downlink BWP corresponding to the uplink BWP on which the random access preamble is received.

Various embodiments may preferably implement the following features:

Preferably or in some embodiments, the PRACH information for a first uplink BWP comprises at least one of: a PRACH configuration for the first uplink BWP, a PRACH BWP selection weight of the first uplink BWP, or a PRACH BWP selection indication of the initial uplink BWP and/or the at least one additional uplink BWP.

Preferably or in some embodiments, the PRACH configuration comprises at least one of: a PRACH resource, or a BWP identifier or an index of a corresponding downlink BWP configured to carry the random access response.

Preferably or in some embodiments, the wireless communication method further comprises: receiving, from the wireless terminal in a second uplink BWP, a capability indication of supporting a random access procedure on the additional uplink BWP.

Preferably or in some embodiments, the capability indication is included in a Message 3, a Message 5, a user equipment capability information message or an uplink media access control control element.

Preferably or in some embodiments, receiving, from the wireless terminal the random access preamble on one of the plurality of uplink BWPs comprises:
transmitting, to the wireless terminal, a preamble configuration of a first additional uplink BWP in the at least one additional uplink BWP, and
receiving, from the wireless terminal in the first additional uplink BWP, the random access preamble associated with the preamble indication.

Preferably or in some embodiments, the preamble configuration is transmitted by or included in downlink control information or a radio resource control message.

Preferably or in some embodiments, the preamble configuration includes at least one of a BWP index of the first additional uplink BWP, uplink frequency information of PRACH resources for the first additional uplink BWP or a preamble index.

The present disclosure relates to a wireless communication method for use in a wireless network node. The method comprises:
receiving, from an access and mobility management function, a paging message for a wireless terminal, wherein the paging message comprising recent communication information of the wireless terminal, and
paging the wireless terminal based on the recent communication information.

Various embodiments may preferably implement the following features:

Preferably or in some embodiments, the wireless communication method further comprises transmitting, to the access and mobility management function, a message comprising an indication of the wireless terminal entering an inactive state and the recent communication information of the wireless terminal.

Preferably or in some embodiments, the recent communication information comprises at least one of information related to at least one recently used cell or information related to at least one recently used synchronization signal/physical broadcast channel block (SSB).

The present disclosure relates to a wireless communication method for use in an access and mobility management function. The method comprises: transmitting, to a wireless network node, a paging message for a wireless terminal, wherein the paging message comprising recent communication information of the wireless terminal.

Various embodiments may preferably implement the following features:

Preferably or in some embodiments, the wireless communication method further comprises receiving, from the wireless network node, a message comprising an indication of the wireless terminal entering an inactive state and the recent communication information of the wireless terminal.

Preferably or in some embodiments, the recent communication information comprises at least one of information related to at least one recently used cell or information related to at least one recently used synchronization signal/physical broadcast channel block (SSB).

The present disclosure relates to a wireless terminal. The wireless terminal comprises:
a communication unit, configured to receive, from a wireless network node, a system information block of an anchor cell, wherein the system information block of the anchor cell comprises a radio resource configuration for at least one non-anchor cell, and
a processor configured to:
select the anchor cell or one of the at least one non-anchor cell based on the radio resource configuration, and
perform a random access procedure in the selected cell.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to transmit, to a wireless terminal, a system information block of an anchor cell, wherein the system information block of the anchor cell comprises a radio resource configuration for at least one non-anchor cell, and
a processor, configured to perform, with the wireless terminal, a random access procedure on a cell selected from the anchor cell or one of the at least one non-anchor cell.

Various embodiments may preferably implement the following feature:

Preferably or in some embodiments, the processor is further configured to perform any of the aforementioned wireless communication methods.

The present disclosure relates to a wireless terminal. The wireless terminal comprises:
a communication unit, configured to receive, from a wireless network node, a first system information block of a serving cell, wherein the first system information block of the serving cell comprises a second system information block for at least one neighbor cell.

Various embodiments may preferably implement the following feature:

Preferably or in some embodiments, the wireless terminal further comprises a processor configured to perform any of the aforementioned wireless communication methods.

The present disclosure relates to a wireless network node. The wireless network node comprises:
a communication unit, configured to transmit, to a wireless terminal, a first system information block of a serving cell, wherein the first system information block of the serving cell comprises a second system information block for at least one neighbor cell.

Various embodiments may preferably implement the following feature:

Preferably or in some embodiments, the wireless network node further comprises a processor configured to perform any of the aforementioned wireless communication methods.

The present disclosure relates to a wireless terminal. The wireless terminal comprises:
a communication unit, configured to:
receive, from a wireless network node, a system information block associated with a plurality of paging bandwidth parts (BWPs) comprising an initial paging BWP and at least one additional paging BWP,
transmit, to a wireless network node, a capability indication of supporting monitoring a paging message on the additional paging BWP, and
a processor, configured to monitor the paging message on one of the plurality of paging BWPs based on the system information block.

Various embodiments may preferably implement the following feature:

Preferably or in some embodiments, the processor is further configured to perform any of the aforementioned wireless communication methods.

The present disclosure relates to a wireless network node. The wireless network node comprises:
a communication unit, configured to:
transmit, to a wireless terminal, a system information block associated with a plurality of paging bandwidth parts (BWPs) comprising an initial paging BWP and at least one additional paging BWP,
receive, from the wireless terminal, a capability indication of supporting monitoring a paging message on the additional paging BWP, and
transmit the paging message on one of the plurality of paging BWPs based on the system information block.

Various embodiments may preferably implement the following feature:

Preferably or in some embodiments, the wireless network node further comprises a processor configured to perform any of the aforementioned wireless communication methods.

The present disclosure relates to a wireless terminal. The wireless terminal comprises:
a communication unit, configured to:
receive, from a wireless network node, a system information block comprising physical random access channel (PRACH) information associated with a plurality of uplink bandwidth parts (BWPs) comprising an initial uplink BWP and at least one additional uplink BWP,
transmit, to the wireless network node, a random access preamble on one of the plurality of uplink BWPs based on the system information block, and
a processor, configured to monitor a random access response on a downlink BWP corresponding to the uplink BWP on which the random access preamble is transmitted.

Various embodiments may preferably implement the following feature:

Preferably or in some embodiments, the processor is further configured to perform any of the aforementioned wireless communication methods.

The present disclosure relates to wireless network node. The wireless network node comprises:
a communication unit, configured to:
transmit, to a wireless terminal, a system information block comprising physical random access channel (PRACH) information associated with a plurality of uplink bandwidth parts (BWPs) comprising an initial uplink BWP and at least one additional uplink BWP,
receive, from the wireless terminal, a random access preamble on one of the plurality of uplink BWPs, and
transmit, a random access response on a downlink BWP corresponding to the uplink BWP on which the random access preamble is received.

Various embodiments may preferably implement the following feature:

Preferably or in some embodiments, the wireless network node further comprises a processor configured to perform any of the aforementioned wireless communication methods.

The present disclosure relates to a wireless network node. The wireless network node comprises:
a communication unit, configured to receive, from an access and mobility management function, a paging message for a wireless terminal, wherein the paging message comprising recent communication information of the wireless terminal, and
a processor, configured to paging the wireless terminal based on the recent communication information.

Various embodiments may preferably implement the following feature:

Preferably or in some embodiments, the processor is further configured to perform any of the aforementioned wireless communication methods.

The present disclosure relates to a wireless device comprising an access and mobility management function, the wireless device comprising:
a communication unit, configured to transmit, to a wireless network node, a paging message for a wireless terminal, wherein the paging message comprising recent communication information of the wireless terminal.

Various embodiments may preferably implement the following features:

Preferably or in some embodiments, the wireless device further comprises a processor configured to perform any of the aforementioned wireless communication methods.

Preferably or in some embodiments, the wireless device comprising the access and mobility management function refers to the access and mobility management function or a wireless device (e.g., wireless network node/element/entity) comprising/performing at least part of functionalities of the access and mobility management function.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIG. 1 shows a schematic diagram of a process according to an embodiment of the present disclosure.

FIG. 2 shows a schematic diagram of a process according to an embodiment of the present disclosure.

FIG. 3 shows a schematic diagram of a process according to an embodiment of the present disclosure.

FIG. 4 shows a schematic diagram of a process according to an embodiment of the present disclosure.

FIG. 5 shows a schematic diagram of a process according to an embodiment of the present disclosure.

FIG. 6 shows a schematic diagram of a process according to an embodiment of the present disclosure.

FIG. 7 shows a schematic diagram of a process according to an embodiment of the present disclosure.

FIG. 8 shows a schematic diagram of a process according to an embodiment of the present disclosure.

FIG. 9 shows a schematic diagram of a process according to an embodiment of the present disclosure.

FIG. 10 shows an example of a schematic diagram of a wireless terminal according to an embodiment of the present disclosure.

FIG. 11 shows an example of a schematic diagram of a wireless network node according to an embodiment of the present disclosure.

FIG. 12 shows a schematic diagram of a network (architecture) according to an embodiment of the present disclosure.

### DETAILED DESCRIPTION

In an embodiment, to save the power consumption of the radio access network (e.g., the gNB power consumption), the network equipment may try to decrease downlink transmissions (e.g., the downlink common signals and/or signaling). For example, in multiple carriers or multiple inter-frequency cells deployment scenarios, the power consumption is reduced if:
only one carrier (e.g., anchor carrier, UE camping carrier or primary carrier) or the cells in one frequency (e.g., anchor cells, or UE camping cells) provides synchronization signals and/or MIB (master information block) and/or SIB (system information block) and/or PBCH (physical broadcast channel); and
the other carriers (e.g., non-anchor carrier, traffic carriers or NES (network energy saving) carriers) or other cells (e.g., non-anchor cells, traffic cells or NES cells) are used to perform PRACH (physical random access channel) procedure and/or traffic delivery (e.g., the other carriers does not provide the synchronization signals and/or MIB and/or SIB and/or PBCH).

In the following, how to provide the non-anchor cell SI configuration and/or how to select the PRACH resource and/or how to determine the traffic carrier/cell are introduced via exemplified embodiments.

### Non-Anchor SI Configuration and RA Procedure in Non-Anchor Carrier

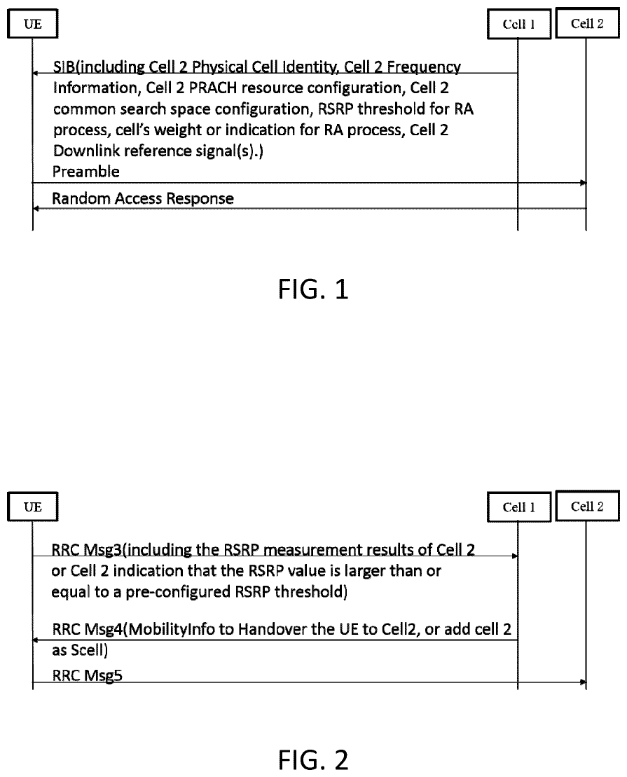

FIG. 1 shows a schematic diagram of a process according to an embodiment of the present disclosure. In FIG. 1, a radio resource configuration used for a random access (RA) procedure of non-anchor carrier(s) or non-anchor cell(s) (e.g., cell2 in FIG. 1) is included in SIB of an anchor carrier or anchor cell (e.g., cell1 in FIG. 1). Note that FIG. 1 shows only 1 cell2 for illustrations.

In an embodiment, the anchor cell is the cell on which the UE camps.

In an embodiment, the non-anchor cell is the cell on which the UE may perform the RA procedure (e.g., PRACH procedure) and/or data/traffic communications.

In an embodiment, the anchor cell and the non-anchor cell may be equal to anchor carrier and non-anchor carrier respectively.

In an embodiment, the non-anchor cell can be one or more cells or one or more carriers in one cell.

In an embodiment, the radio resource configuration used for the RA procedure of (each) the non-anchor carrier or non-anchor cell includes/indicates at least one of:
Physical Cell Identity of the non-anchor cell,
Uplink Frequency Information of the non-anchor cell,
Downlink Frequency Information of the non-anchor cell,
PRACH resource configuration the non-anchor cell,
Common search space configuration the non-anchor cell,
RSRP (reference signal received power) threshold for the RA process,
Weight or indication the non-anchor cell for the RA process, or
Downlink reference signal(s) of the non-anchor cell.

In an embodiment, if the Physical Cell Identity of the non-anchor cell is not included in radio resource configuration for the non-anchor carrier or cell, the Physical Cell Identity of the anchor cell is used as the Physical Cell Identity of the non-anchor cell. Under such conditions, it can be seen as a multiple carrier cell (e.g., one cell with multiple carriers). For example, the cell1 and cell2 in FIG. 1 may be separate carriers in the same cell if the radio resource configuration, which is in the SIB of cell1 and for the cell2, does not include the Physical Cell Identity of the cell2.

In an embodiment, if the Downlink reference signal(s) of the non-anchor cell is not included/indicated in the radio resource configuration for the non-anchor carrier/cell, the measurement result of the anchor cell or measurement result of another non-anchor cell is used for measurement of this the non-anchor cell (e.g., it is assumed that Downlink reference signal(s) of the anchor cell is also used for the non-anchor cell if the Downlink reference signal(s) is not configured for the non-anchor cell; or multiple non-anchor cells use common Downlink reference signal(s); or a first non-anchor cell uses Downlink reference signal(s) of a second non-anchor cell if the Downlink reference signal(s) is not configured for the first non-anchor cell). If the Downlink reference signal(s) of the non-anchor cell is included in the radio resource configuration for the non-anchor carrier or cell, the UE performs the RSRP measurement for the non-anchor cell before performing the random access procedure.

In an embodiment, an indication on whether the SSB (SS/PBCH Block) is configured for the non-anchor cell, or an indication on whether the SSB includes the PBCH or the MIB (e.g., only synchronization signal is transmitted and the PBCH is not transmitted).

In an embodiment, the DL frequency information of the non-anchor cell may be included in the PRACH resource configuration of the non-anchor cell (e.g., associated with the PRACH resources) or included in the configuration information of the non-anchor cell (e.g., associated with the downlink frequency information of the non-anchor cell).

In an embodiment, the RSRP threshold of the non-anchor cell for the RA process is used to determine whether the UE can perform the RA process on the non-anchor cell. If the RSRP of the Non-anchor cell or of a Beam of the non-anchor cell is larger than or equal to the RSRP threshold of the non-anchor cell for the RA procedure, the UE can perform the RA procedure by using the random access resources of the non-anchor cell or the Beam of the non-anchor cell. The RSRP threshold of the non-anchor cell can be one common threshold for all of the non-anchor cells. As an alternative, the RSRP threshold may be configured per non-anchor cell, per SSB, or per PRACH resource (e.g., (legacy) PRACH resource, Redcap (reduced capability) PRACH resource, SDT (small data transmission) PRACH resource).

In an embodiment, the PRACH resource configuration of the non-anchor cell can also be initial Uplink BWP (Bandwidth Part) or Uplink Common BWP. (e.g., PRACH resource configuration is included in initialUplinkBWP or BWP-UplinkCommon). Note that the name of resource element comprising the PRACH resource configuration may change. In addition, the resource element comprising the PRACH resource configuration may further comprises at least one of frequency domain locations of the PRACH resources, a CSS-RA (common search space for Random Access procedure) information configuration, PCCH (paging control channel) information configuration or CSS frequency domain location.

In an embodiment, the CSS configuration can also be common Resource Set, initialDownlinkBWP or BWP-DownlinkCommon (e.g., the CSS configuration is included in initialDownlinkBWP or BWP-DownlinkCommon).

In an embodiment, the weight or indication of the cell for the RA process is used to balance the random access load between the anchor cell and the non-anchor cell(s). For instance, the UE not supporting the random access in the non-anchor cell can only perform the random access in the anchor cell. Thus, the weight or indication of the cell for the Random Access process is used to indicate at least part (e.g., a part or all) of the UEs supporting the random access in the non-anchor cell performs the random access in the non-anchor cell.

In an embodiment, the weight or indication of the cell for the Random Access process may be related to:
Anchor carrier/anchor cell and non-anchor carrier/cell: For example, all of the non-anchor carriers or cells with PRACH resources has the same weight or indication,
Each carrier or each cell: For instance, each cell with the PRACH resource has its own weight or indication.
PRACH resource type: In an embodiment, the PRACH resource types may be one of legacy PRACH resource, Redcap PRACH resource, SDT PRACH resource. Different PRACH resource types can be configured with different weights or indications. The UE selects the weight or indication based on the PRACH resource type.

In an embodiment, the radio resource configuration used for the random access procedure of the non-anchor carrier/cell (e.g., cell2 in FIG. 1) is included in the SIB of the anchor carrier/cell cell (e.g. cell1 in FIG. 1), the UE in the anchor carrier may perform the random access in the non-anchor carrier/cell based on the embodiments for PRACH Resource Selection.

### Neighbor Cell Measurements:

In an embodiment of the UE in the RRC_IDLE or RRC_INACTIVE state except the PRACH procedure, the intra-frequency measurement is assumed by the UE to be the measurement of the anchor carrier or anchor cell.

In an embodiment of the UE in the PRACH procedure, the intra-frequency measurement is assumed by the UE to be the measurement of the anchor carrier or anchor cell. As an alternative, the intra-frequency measurement is assumed by the UE to be the measurement of the carrier or cell used for the random access response. If the UE assumes the intra-frequency measurement is the measurement of the carrier or cell used for random access response, the radio resource configuration used for the random access procedure of the non-anchor carrier/cell may also include the neighbor cell information of the non-anchor cell (e.g., cell re-selection information for intra-frequency, neighboring cell related information for intra-frequency cell re-selection, neighboring cell related information for inter-frequency cell re-selection).

In an embodiment of the UE in the RRC_CONNECTED state, the intra-frequency measurement is assumed by the UE to be measurement of the anchor carrier or anchor cell. As an alternative, the UE may assume the intra-frequency measurement to be the measurement of the traffic carrier or traffic cell (i.e., the cell/carrier used for traffic communications). If the UE assumes the intra-frequency measurement to be the measurement of the traffic carrier or traffic cell, or used pcell (primary cell), the intra-frequency and/or inter-frequency cell related information may be configured based on the traffic carrier or traffic cell, or used pcell (e.g., the intra-frequency measurement is measurement of the traffic carrier or traffic cell, or used pcell).

### PRACH Resource Selection Procedure

In an embodiment, the Downlink reference signal(s) of the non-anchor cell(s) is not included in the radio resource configuration for the non-anchor carrier or cell and the weight for the RA procedure/process is configured per cell. In this embodiment, the UE selects the anchor cell or one of the non-anchor cells for random access based on the cell's weight for RA process. The UE then selects the preamble in the selected cell for the random access procedure.

In an embodiment, the Downlink reference signal(s) of the non-anchor cell(s) is not included in the radio resource configuration for the non-anchor cell(s). In this embodiment, the weight for the RA process is configured for the anchor cell and/or one weight is configured for all the non-anchor cells. Under such conditions, the UE selects the anchor cell or the non-anchor cell(s) for the random access procedure based on the weight(s) of the anchor cell and/or non-anchor cell(s) for the RA process. If the non-anchor cell(s) is selected, the UE randomly and with equal probability selects the preamble among the non-anchor cells or non-anchor cell beams with the RSRP value larger than or equal to the RSRP threshold. For example, the selection probability is equal for all non-anchor carrier PRACH resources and the probability of selecting one PRACH resource is (1-prach-Probability Anchor)/(the number of non-anchor PRACH resources), where prach-Probability Anchor is the probability of the UE selecting the anchor cell.

In an embodiment, the Downlink reference signal(s) of the non-anchor cell(s) is not included in the radio resource configuration for the non-anchor cell(s) and the indication of cell for the RA process indicates that the UE supporting the random access in the non-anchor cell perform the random access (only) in the non-anchor cell. In this embodiment, the UE supporting the random access in the non-anchor cell randomly but with equal probability selects the preamble among the non-anchor cells or non-anchor cell beams with the RSRP value larger than or equal to the RSRP threshold. For instance, the selection probability is equal for all non-anchor carrier PRACH resources and the probability of selecting one PRACH resource is 1/(the number of non-anchor PRACH resources).

In an embodiment, the Downlink reference signal(s) of the non-anchor cell(s) is not included in the radio resource configuration for the non-anchor cell(s), and the indication of cell for the RA process indicates that the UEs supporting the random access in the non-anchor cell can perform the random access in the anchor cell or non-anchor cell. In this embodiment, the UE supporting the random access in the non-anchor cell randomly but with equal probability selects the preamble among the anchor cell, anchor cell beams, or non-anchor cells or non-anchor cell beams with the RSRP value larger than or equal to the RSRP threshold. For example, the selection probability is equal for each usable PRACH resource and the probability of selecting one PRACH resource is 1/(the number of PRACH resources).

In an embodiment, the Downlink reference signal(s) of the non-anchor cell(s) is included in the radio resource configuration for the non-anchor cell and the weight of the cell for RA process is configured per cell. In this embodiment, the UE measures the RSRP of each non-anchor cell and selects the cells with the RSRP value larger than or equal to the RSRP threshold and the anchor cell as the candidate cell(s) for the random access. Next, the UE selects the cell for the random access from the candidate cells based on the weights of the candidate cells for the random access and selects the preamble in the selected cell for the random access.

In an embodiment, the Downlink reference signal(s) of the non-anchor cells) is included in the radio resource configuration for the non-anchor cell. In this embodiment, the weight of the cell for the RA process is configured for the anchor cell and/or one weight is configured for all the non-anchor cells. Under such conditions, the UE measures the RSRP of each non-anchor cell and selects the cells with the RSRP value larger than or equal to the RSRP threshold and anchor cell as the candidate cells for the random access. If there is at least one of the non-anchor cell is among the candidate cells for the random access, the UE selects the anchor cell or non-anchor cell(s) for the random access based on the weight of the anchor cell and the weights of all non-anchor cells. If the non-anchor cell(s) is selected, the UE randomly but with equal probability selects the preamble among the non-anchor cells or non-anchor cell beams with the RSRP value larger than or equal to the RSRP threshold. That is the selection probability is equal for all non-anchor carrier PRACH resources and the probability of selecting one PRACH resource is (1-prach-ProbabilityAnchor)/(the number of non-anchor PRACH resources).

In an embodiment, the Downlink reference signal(s) of the non-anchor cell(s) is included in the radio resource configuration for the non-anchor cell and the indication of the cell for RA process indicates that the UEs supporting the random access in the non-anchor cell perform random access only in the non-anchor cell. In this embodiment, the UE supporting the random access in the non-anchor cell measures the RSRP of non-anchor cell and selects the non-anchor cells with the RSRP value is larger than or equal to the RSRP threshold as the candidate cells for the random access. The UE supporting random access in the non-anchor cell randomly but with equal probability selects the preamble among those for the candidate cells for the random access. For example, the selection probability is equal for all non-anchor cell PRACH resources and the probability of selecting one PRACH resource is 1/(the number of non-anchor PRACH resources).

In an embodiment, the Downlink reference signal(s) of the non-anchor cell(s) is included in the radio resource configuration for the non-anchor cell and the indication of the cell for the RA process indicates that the UEs supporting the random access in the non-anchor cell can perform the random access in the anchor cell or the non-anchor cell. In this embodiment, the UE supporting the random access in the non-anchor cell measures the RSRP of each non-anchor cell and selects the cells with the RSRP value larger than or equal to the RSRP threshold and the anchor cell as the candidate cells for the random access. The UE supporting the random access in the non-anchor cell randomly but with equal probability selects the preamble among those of the anchor cell, anchor cell beams, or non-anchor cells or non-anchor cell beams with the RSRP value larger than or equal to the RSRP threshold. For instance, the selection probability is equal for the usable PRACH resources and the probability of selecting one PRACH resource is 1/(the number of PRACH resources).

### Traffic Cell Assignment Procedure

FIG. 2 shows a schematic diagram of a traffic cell assignment procedure according to an embodiment of the present disclosure. In FIG. 2, the UE sends the RSRP measurement results of non-anchor cell(s) (e.g., cell2) to the gNB or sends a non-anchor cell indication that the RSRP value of the non-anchor cell(s) is larger than or equal to a pre-configured RSRP threshold. In an embodiment, the UE sends these information in the RRC Message 3 (in the random access procedure). In an embodiment, the pre-configured RSRP threshold is sent to the UE by the SIB, the MAC CE or the RAR message. Based on the RSRP measurement results of the non-anchor cell(s) or the non-anchor cell indication, the gNB can handover the UE to the non-anchor cell or add the non-anchor cell as a Scell (secondary cell), e.g., in a case of CA (carrier aggregation) or DC (dual-connectivity).

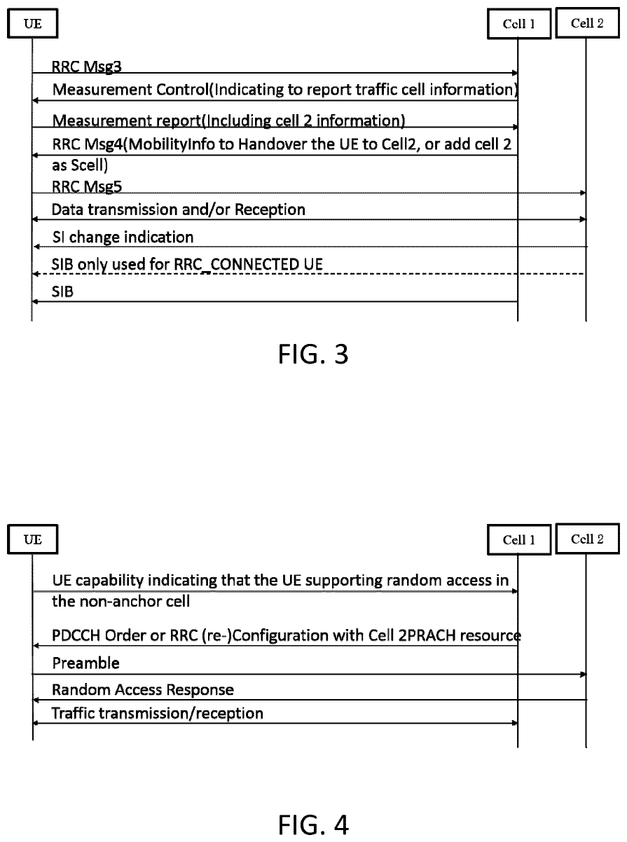

FIG. 3 shows a schematic diagram of a traffic cell assignment procedure according to an embodiment of the present disclosure. In FIG. 3, after the RRC message 3, the gNB in the Cell1 (e.g., in which the UE performs the random access procedure) sends the measurement control information to indicate the UE to report available traffic cell information. In an embodiment, the measurement control information includes at least one of: the candidate cell list to be reported, an RSRP threshold for the non-anchor cell/or neighbor cell measurement report. In an embodiment, the measurement control information is sent to the UE via the RRC message, the MAC CE or the DCI.

After receiving of the measurement control information, the UE sends the RSRP measurement results of non-anchor cell(s) (e.g., cell2) to the gNB or sends the non-anchor cell indication that the RSRP value is larger than or equal to the pre-configured RSRP threshold. In an embodiment, the pre-configured RSRP threshold is sent to the UE by the SIB, the MAC CE or the RRC message.

Based on the RSRP measurement results of the non-anchor cell(s) or the non-anchor cell indication, the gNB can handover the UE to the non-anchor cell or add the non-anchor cell as the Scell (e.g., for the CA or the DC).

In some embodiments of FIG. 2 and FIG. 3, the non-anchor cell (e.g., cell2) may not send the SIB or only send the SIB information used for the RRC_CONNECTED state. That is the gNB may not send, to the UE, the SIB in the cell2 or may send, to the UE, the SIB used for the RRC_CONNECTED state in cell2.

In some embodiments of FIG. 2 and FIG. 3, after receiving the SI update indication, the RRC_CONNECTED UE in the non-anchor cell can receive the SI from the Anchor cell (cell1) or only receive the SIB information used for RRC_CONNECTED state from the traffic cell (e.g., cell2).

FIG. 4 shows a schematic diagram of a procedure according to an embodiment of the present disclosure. The procedure shown in FIG. 4, relates to non-anchor RA capability used for PDCCH order or Radio Resource Configuration.

Specifically, the UE reports its capability indicating that the UE supporting the random access in the non-anchor cell in the RRC Message3, RRC Message5, a UE Capability Information message or a UL MAC CE.

After/Upon receiving the UE capability indicating that the UE supporting the random access in the non-anchor cell, the gNB may allocate preamble of one non-anchor cell to the UE by PDCCH order or downlink RRC Message. In an embodiment, a cell index or carrier index is included in the preamble configuration)

After/Upon receiving the preamble of one non-anchor cell, the UE performs the random access procedure on the non-anchor cell by using the assigned preamble at the pre-defined preamble occasion. After the random access procedure (e.g., receiving the Random Access response message), the UE returns back to the traffic cell (e.g., cell 1 by which the UE used in RRC_CONNECTED state) to perform traffic transmissions/receptions.

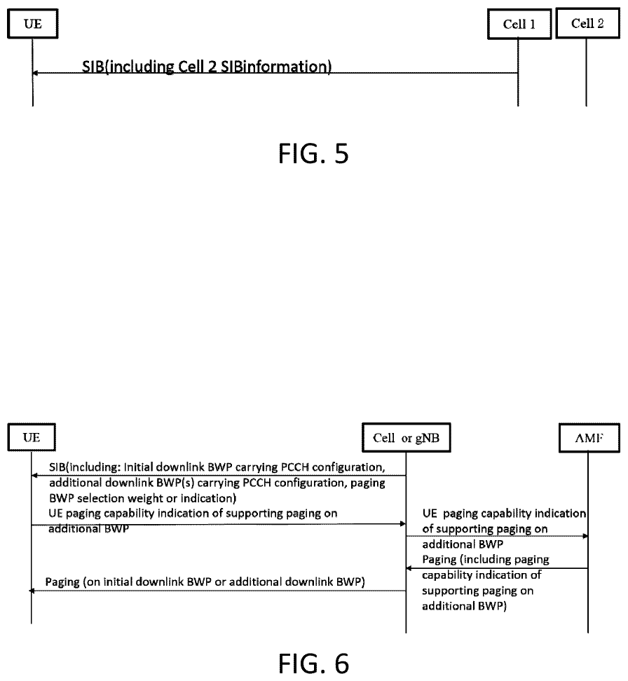

FIG. 5 shows a schematic diagram of a process according to an embodiment of the present disclosure. In FIG. 5, the SIB information of the serving/anchor cell (e.g., cell1) includes the SIB of the neighbor/non-anchor cell (e.g., cell2).

In an embodiment, the UE may perform certain operations based on the SIB of the neighbor/non-anchor cell (e.g., cell2). For example, the UE may switch to (e.g., communicate with the gNB in) the neighbor cell or the non-anchor cell or may be handed over to the neighbor cell or the non-anchor cell.

In some embodiments, if the UE in the serving cell acquires the SIB of the neighbor cell or the non-anchor cell, the delay caused by acquiring the SIB information of the of the neighbor cell or the non-anchor cell after the UE switches to the neighbor cell or non-anchor cell can be reduced.

In some embodiments, if the SIB information of the neighbor cell or the non-anchor cell is the same as that the serving cell, the UE may avoid acquiring the SIB of the neighbor cell or the non-anchor cell after switching to the neighbor cell or the non-anchor cell.

In an embodiment of the SIB information of neighbor cell or non-anchor cell (e.g., cell2) being included in the SIB of the serving cell (e.g., cell1), the SIB information of the neighbor cell or the non-anchor cell may comprise at least one of:
indication that a certain part of SIB of the neighbor cell or the non-anchor cell (e.g., cell2) is the same as that of the serving cell,
the SIB of the neighbor cell or the non-anchor cell, or
delta SIB information including difference(s) between the SIB of the neighbor cell or the non-anchor cell relative to that of the serving cell (e.g., parts of the SIB of the neighbor cell or the non-anchor cell).

In an embodiment, the SIB information of the neighbor cell or the non-anchor cell included in the SIB of the serving cell may only include the delta SIB information associated with the difference(s) between the SIB of the neighbor cell or non-anchor cell and that of the serving cell.

In an embodiment, the SIB information of the neighbor cell or the non-anchor cell can be included in an RRC Container or in a pre-defined SIB of the serving cell.

Multiple PAGING BWPs and/or Multiple PRACH BWPs Per Cell

FIG. 6 shows a schematic diagram of a procedure according to an embodiment of the present disclosure. In FIG. 6, multiple PAGING BWPs are configured per cell.

Specifically, the cell or gNB sends, in the SIB, at least one of:
paging BWP(s) carrying PCCH configuration(s),
paging BWP selection weight(s), or
paging BWP selection indication.

In an embodiment, the multiple PAGING BWPs comprises an initial PAGING BWP and additional PAGING BWP(s) (e.g., downlink (common) BWP(s)).

In an embodiment, the paging BWP selection weight may be configured per PAGING BWP. As an alternative, the initial PAGING BWP has its own the paging BWP selection weight and/or all of the additional PAGING BWPs has a common paging BWP selection weight.

The UE sends, to the cell or gNB, UE paging capability on whether supporting monitoring paging on the additional downlink BWP, wherein the UE paging capability can be sent via the RRC message (e.g., UECapabilityInformation). In an embodiment, the transmission of the UE paging capability may be omitted if the UE is assumed to not support monitoring paging on the additional downlink BWP.

In an embodiment, the multiple PAGING BWP(s) can also be multiple downlink BWP(s), or multiple downlink common resource configuration set, which includes at least one of: Common search space used for paging monitoring, Common search space used for Downlink monitoring during the random access procedure (e.g. monitoring the Random access response and/or the RRC Message4), or frequency domain information related to the downlink common resource configuration.

Note that, in the present disclosure, the cell sends information/signaling/data to a wireless device (e.g., UE or AMF) may represent that the base station (e.g., RAN node, gNB) sends the information/signaling/data in the cell or by using the cell or via the cell.

The cell or the gNB sends, to AMF, the UE paging capability, wherein the UE paging capability may be sent by the NGAP message (e.g., in UE Radio Capability for Paging Information Element of UE RADIO CAPABILITY INFO INDICATION message).

The AMF sends, to the cell/gNB, the paging (message) including the UE paging capability on whether supporting monitoring the paging on the additional downlink BWP, which can be sent by the NGAP paging message (e.g., in UE Radio Capability for Paging Information Element).

Based on the SIB information (including at least one of: the multiple downlink BWP(s) carrying PCCH configuration(s), the paging BWP selection weight(s) or the paging BWP selection indication) and the UE paging capability, the cell/gNB selects an initial downlink BWP or one of the additional downlink BWP(s) carrying the PCCH configuration(s) as the downlink BWP of sending the paging to the UE.

On the other hand, based on the SIB information (including at least one of: the multiple downlink BWP(s) carrying PCCH configuration, the paging BWP selection weight(s) or the paging BWP selection indication) and the UE paging capability of whether supporting paging on additional BWP, the UE selects the initial downlink BWP or one of the additional downlink BWP(s) carrying PCCH configuration(s) as the downlink BWP for monitoring the paging. The UE monitors the paging on the selected downlink BWP.

Mechanism of the UE, cell or gNB selecting the downlink BWP for paging are illustrated in the following embodiments.

In some embodiments, the UE only can select the initial downlink BWP for paging. That is the UE does not support monitoring the paging on the additional downlink BWP. Thus, the UE selects the initial downlink BWP and monitor the paging on the initial downlink BWP.

In some embodiments, the UE supports monitoring the paging on the additional downlink BWP. In these embodiments, the UE selects the downlink BWP for paging as the following embodiments:

### Case 1:

In an embodiment, the paging BWP selection weight is configured per BWP carrying the PCCH configuration in the SIB. For example, the weight is an integer configured for each BWP. As an alternative, the weight is a relative number (%) or a ratio, which may be transferred to an integer. For instance, the two weights 50% and 50% are configured for two BWPs carrying the PCCH configuration and these two weights are transferred to 1 and 1 based on 50%: 50%=1:1.

In this embodiment, the UE selects the downlink BWP for paging based on the configured paging BWP selection weights and a UE identity based on the following embodiments.

In an embodiment, if the UE supports (monitoring) the paging on the additional downlink BWP and if the additional downlink BWPs carrying the PCCH configurations are provided in the SIB, the downlink BWP selected for monitoring the paging is the downlink BWP with the smallest index n (0≤n≤the number of additional downlink BWPs carrying the PCCH configuration) fulfilling the following equation:

$$floor ( UE\_ID / ( N * Ns ) ) mod W < W ( 0 ) + W ( 1 ) + … + W ( n )$$

wherein:
the W(i) is the paging BWP selection weight for the downlink BWP with the index i. For example, W(0) is the paging BWP selection weight for the downlink BWP with the index 0 (e.g., the initial downlink BWP); W(1) is the paging BWP selection weight for the downlink BWP with the index 1 (e.g., the first additional downlink BWP carrying PCCH configuration), and so on;
W is the total weight of those of all downlink BWPs carrying the PCCH configuration of the cell, i.e. W=W (0)+W (1)+ . . . +W (m), where m is the Number of the additional downlink BWPs carrying the PCCH configurations;
N is the number of total paging frames in a period T;
Ns is the number of paging occasions for a paging frame; and
UE_ID is a UE identity (e.g., 5G-S-TMSI) mod X, where X is an integer.

In the present disclosure, the term “mod” represents modulo function. For instance, a number H mod a number K (i.e., H mod K) means acquiring the remainder of the division of H by K.

In the present disclosure, floor ( ) represents the floor function of acquiring the maximum integer smaller than or equal to an input variable.

### Case 2:

In an embodiment, the paging BWP selection weights are configured for the initial downlink BWP and the additional downlink BWP(s) carrying the PCCH configuration(s) (e.g., all the additional downlink BWPs carrying the PCCH configurations share one weight).

In this embodiment, the UE selects the downlink BWP for paging based on the paging BWP selection weights and the UE identity as the followings:

If the UE supports (monitoring) paging on the additional downlink BWP and if the additional downlink BWP(s) carrying the PCCH configuration(s) is provided in system information (e.g., SIB), the paging BWP is determined based on:
if floor (UE_ID/(N*Ns*X))≤paging BWP selection weight of the initial downlink BWP; or
if the UE_ID/(N*Ns*X)≤paging BWP selection weight of initial downlink BWP;
the UE selects the initial downlink BWP for paging;
else, the UE selects one of the additional downlink BWPs for paging based on the following rules:
paging BWP index=floor (UE_ID/(N*Ns)) mod M.
where:
N is the number of total paging frames in a period T;
Ns is the number of paging occasions for a paging frame;
UE_ID is a UE identity (e.g., 5G-S-TMSI) mod X, where X is an integer; and
M is the Number of additional downlink BWPs carrying the PCCH configurations.

In an embodiment, the Paging BWP index=0 indicates that the first additional downlink BWP is selected for paging, the Paging BWP index=1 indicates that the second additional downlink BWP is selected for paging, and so on.

### Case 3:

In an embodiment, the paging BWP selection indication is configured for the initial downlink BWP and indicates that the UE supporting monitoring the paging on the additional downlink BWP monitors the paging only on additional downlink BWP.

In this embodiment, the UE selects the downlink BWP for paging based on the paging BWP selection weight and the UE identity as the followings:

If the UE supports (monitoring) the paging on the additional downlink BWP and if the additional downlink BWP(s) carrying the PCCH configuration(s) is provided in the system information (e.g., SIB), the paging BWP is the BWP fulfilling the following equation:

Paging BWP index=floor(UE_ID/(N*Ns))mod M
wherein:
N is the number of total paging frames in a period T;
Ns is the number of paging occasions for a paging frame;
UE_ID is a UE identity (e.g., 5G-S-TMSI) mod X, where X is an integer; and
M is the Number of additional downlink BWPs carrying the PCCH configurations.

In an embodiment, the Paging BWP index-0 indicates that the first additional downlink BWP is selected for paging, the Paging BWP index=1 indicates that the second additional downlink BWP is selected for paging, and so on.

### Case 4:

In an embodiment, the paging BWP selection indication is configured for the initial downlink BWP and indicates that the UE supporting monitoring the paging on the additional downlink BWP monitors the paging on the initial downlink BWP or the additional downlink BWP.

In this embodiment, the UE selects the downlink BWP for paging based on the paging BWP selection weight(s), UE identity as followings:

If UE supports the paging on the additional downlink BWP and if the additional downlink BWP(s) carrying the PCCH configuration(s) is provided in the system information, the paging BWP is the paging BWP fulfilling the following equation:

$$Paging BWP index = floor ( UE\_ID / N * Ns ) ) mod ( M + 1 )$$

wherein:
N is the number of total paging frames in a period T;
Ns is the number of paging occasions for a paging frame;
UE_ID is a UE identity (e.g., 5G-S-TMSI) mod X, where X is an integer; and
M is the Number of additional downlink BWPs carrying the PCCH configurations.

For example, the Paging BWP index=0 indicates that the initial downlink BWP is selected for paging the Paging BWP index=1 indicates that the first additional downlink BWP is selected for paging, the Paging BWP index=2 indicates that the second additional downlink BWP is selected for paging, and so on.

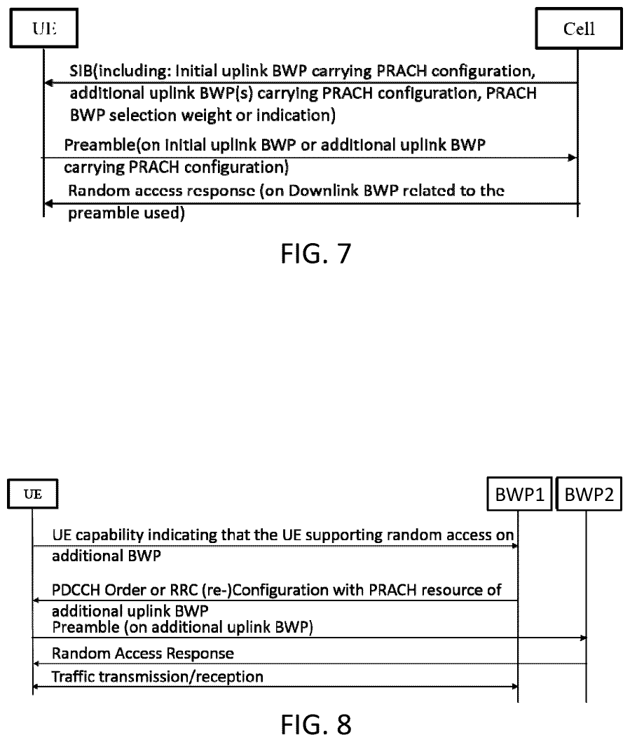

FIG. 7 shows a schematic diagram of a procedure according to an embodiment of the present disclosure. In FIG. 7, the multiple NPRACH BWP is configured per cell. In an embodiment, the multiple NPRACH BWP(s) can also be multiple uplink BWP(s) or multiple uplink common resource configuration, which includes frequency domain information related to the uplink common resource configuration and PRACH configuration.

In the embodiment shown in FIG. 7, the cell or gNB sends, in the SIB of the cell, at least one of: multiple uplink BWP(s) carrying the PRACH configuration(s), the PRACH BWP selection weight(s) or the PRACH BWP selection indication.

In an embodiment, the PRACH configuration includes at least one of: NPRACH resource, or a BWP ID or index of the downlink BWP carrying the random access response. In an embodiment, the BWP ID or index of the downlink BWP carrying the random access response can be configured per PRACH resource type (e.g. legacy PRACH resource, redcap PRACH resource or SDT PRACH resource).

In an embodiment, if the UE supports the PRACH procedure on the additional uplink BWP and if the additional uplink BWP(s) carrying the PRACH configuration(s) is provided in the system information (e.g., SIB), the UE selects the initial uplink BWP or one of the additional uplink BWP(s) as the BWP on which the PRACH procedure (e.g., transmitting a PRACH preamble to the cell or gNB) is performed based on the PRACH BWP selection weight or the PRACH BWP selection indication.

In the present disclosure, the additional uplink BWP may be uplink common BWP.

After/Upon receiving the preamble, the gNB sends the random access response on the downlink BWP related to the preamble.

After sending the preamble on the selected uplink BWP, the UE monitors the random access response on the downlink BWP related to the preamble.

The mechanism of the UE selecting the PRACH BWP is similar to that in the above embodiments for the PRACH Resource Selection Procedure. For example, the mechanism of the UE selecting the PRACH BWP may be acquired by substituting the anchor cell and the non-anchor cell respectively by the initial uplink BWP and the additional uplink BWP.

For example, the UE may select the PRACH BWP based on the following cases:

### Case 1:

In an embodiment, if the weight of the uplink BWP for the PRACH procedure is configured per BWP with the configured NPRACH resource, the UE selects the initial uplink BWP or one of the additional uplink BWP(s) for the PRACH procedure based on the weight of each BWP for the PRACH procedure and selects the preamble in the selected BWP for the PRACH procedure.

### Case 2:

In an embodiment, the weight of the BWP for the RA process is configured for the initial uplink BWP and/or one weight configured for all the additional uplink BWPs.

In this embodiment, the UE selects the initial uplink BWP or the additional uplink BWP(s) for the random access based on the weight of the BWP for the RA process. If the additional uplink BWP(s) is selected, the UE randomly but with equal probability selects the preamble among the additional uplink BWPs or additional uplink BWP beams with the RSRP value larger than or equal to the RSRP threshold. For example, the selection probability is equal for all additional uplink BWPs and the probability of one additional uplink BWP is selected is (1-ProbabilityInitialBWP)/(the number of additional uplink BWPs), wherein

ProbabilityInitialBWP is the probability of selecting the initial uplink BWP (e.g., the weight of the initial BWP for the RA process).

As an alternative, the selection probability is equal for all the available NPRACH resources among the additional uplink BWPs. For example, the NPRACH resource may be configured per BWP. That is different BWPs may have different NPRACH resources. In this embodiment, the probability of selecting one PRACH resource among the additional uplink BWPs is (1-ProbabilityInitialBWP)/(the number of available NPRACH resources among the additional uplink BWPs), wherein ProbabilityInitialBWP is the probability of selecting the initial uplink BWP (e.g., the weight of the initial BWP for the RA process).

### Case 3:

In an embodiment, the indication of the BWP for the RA process indicates that the UEs supporting the random access on the additional uplink BWP perform the random access only on the additional uplink BWP. In this embodiment, the UE supporting the random access in the additional uplink BWP randomly but with equal probability selects the preamble among the additional uplink BWPs or additional uplink BWP beams with the RSRP value larger than or equal to the RSRP threshold. For instance, the selection probability is equal for all additional uplink BWPs and the probability of one additional uplink BWP being selected is 1/(the number of the additional uplink BWPs).

As an alternative, the selection probability is equal for all the available NPRACH resources among the additional uplink BWPs. For example, the NPRACH resource may be configured per BWP and different BWPs may have different NPRACH resources. In this embodiment, the probability of selecting one PRACH resource among the additional uplink BWPs is 1/(the number of available NPRACH resources among the additional uplink BWPs).

### Case 4:

In an embodiment, the indication of the BWP for the RA process indicates that the UEs supporting the random access on the additional uplink BWP can perform the random access on the initial uplink BWP or the additional uplink BWP. In this embodiment, The UE supporting the random access on the additional uplink BWP randomly but with equal probability selects the preamble among the initial uplink BWP or the addition uplink BWP carrying NPRACH configuration, or related beams with the RSRP value larger than or equal to the RSRP threshold. For example, the selection probability is equal for the usable BWPs (i.e., the initial BWP and the additional BWP with the RSRP value greater than or equal to the RSRP threshold) and the probability of one usable BWP being selected is 1/(the number of usable BWPs).

As an alternative, the selection probability is equal for all the available NPRACH resources among the usable BWPs (i.e., the initial BWP and the additional BWP with the RSRP value greater than or equal to the RSRP threshold) and the probability of selecting one PRACH resource among the usable BWPs is 1/(the number of available NPRACH resources among the usable BWPs).

FIG. 8 shows a schematic diagram of a procedure according to an embodiment of the present disclosure. In FIG. 8, the UE reports capability of supporting the random access procedure on the additional uplink BWP used for PDCCH order or Radio resource Configuration.

The mechanism shown in FIG. 8 is similar to that shown in FIG. 4, e.g., if replacing the non-anchor cell by the additional uplink BWP.

Specifically, the UE reports its capability indicating that the UE supporting the random access in the additional uplink BWP (e.g., BWP2 in FIG. 8), e.g., by the RRC Message3, RRC Message5, the UE Capability Information message or the UL MAC CE. In FIG. 8, the UE may report the capability on the BWP1 (e.g., active BWP).

After/Upon receiving the UE capability indicating that the UE supporting the random access in the additional uplink BWP, the gNB may allocate the preamble of one additional uplink BWP to the UE by a PDCCH order or downlink RRC Message (e.g., BWP index or BWP ID are included in the preamble configuration).

After/Upon receiving the preamble of the additional uplink BWP, the UE performs the random access procedure on the additional uplink BWP with the assigned preamble (e.g., BWP2 in FIG. 8) at the pre-defined preamble occasion. After the random access procedure (e.g., receiving the Random Access response message), the UE returns back to the dedicated BWP (e.g., BWP1 in FIG. 8) to perform traffic transmissions/receptions.

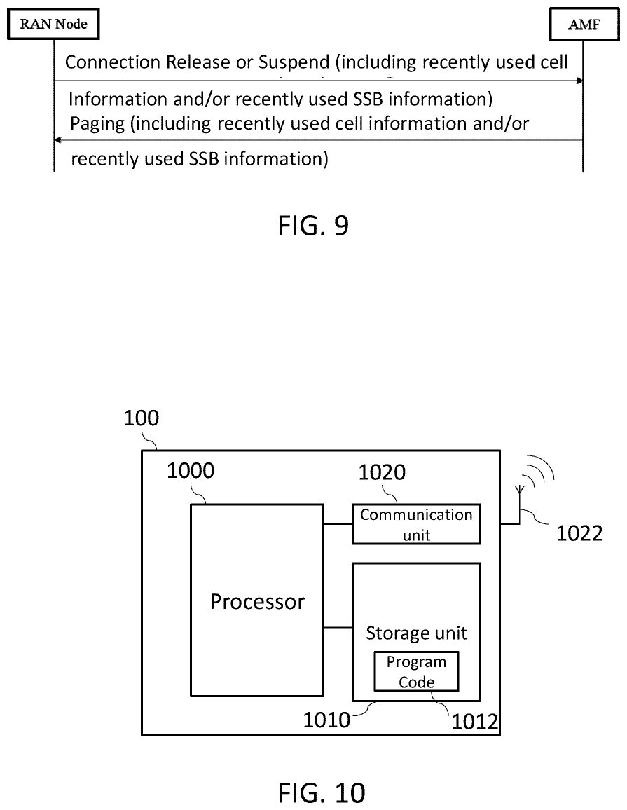

FIG. 9 shows a schematic diagram of a procedure according to an embodiment of the present disclosure. In FIG. 9, the paging may be performed in a limited area.

In the embodiment shown in FIG. 9, the RAN node (e.g., gNB) sends a Connection Release or Connection Suspend message to the AMF to indicate that the UE enters the RRC_IDLE state or RRC_INACTIVE state, wherein the Connection Release or Connection Suspend message includes recently used cell information of the UE (e.g., information of cell(s) recently used by the UE or information of cell(s) in which the UE recently stays)) and/or recently used SSB information of the UE (e.g., information of SSB(s) recently used by the UE or information of SSB(s) in which the UE recently stays).

The AMF sends a PAGING message to the RAN node, wherein the PAGING message includes the recently used cell information and/or the recently used SSB information.

Upon/After receiving the recently used cell information and recently used SSB information in the PAGING message, the RAN node pages the UE based on the recently used cell information and/or the recently used SSB information. For example, the gNB may pages the UE in the latest used cell and the latest used SSB(s) of the UE. If the paging fails, the RAN node re-paging the UE in all the SSBs within the cell.

In an embodiment, the Connection Release or Connection Suspend message includes at least one of: UE CONTEXT RELEASE COMPLETE, UE CONTEXT SUSPEND REQUEST, UE CONTEXT RESUME REQUEST.

In an embodiment, the recently used cell information refers to the information of the recently used cell(s) of the UE. For example, the recently used cell information includes one or more (e.g., a list) of information related to the used cell of the UE. The information related to the used cell includes at least one of: cell Identity or Time duration the UE staying in the cell. In an embodiment, the recently used cell information may comprise (only) the information of the latest cell used by the UE or the latest cell in which the UE stays.

In an embodiment, the recently used SSB information refers to the information of the recently used SSB(s) of the UE. For instance, the recently used SSB information includes one or more (e.g., a list) of information related to the SSB(s) recently used by the UE. The information related to each recently used SSB includes at least one of: SSB index, SSB Identity, Time duration of the UE staying in the SSB. In an embodiment, the recently used SSB information may comprise (only) the information of the latest SSB used by the UE or the latest SSB in which the UE stays.

In an embodiment, the recently used cell can also be called as the recommended cell for paging.

In an embodiment, the recently used SSB can also be named as the recommended SSB for paging.

FIG. 10 relates to a schematic diagram of a wireless terminal 100 according to an embodiment of the present disclosure. The wireless terminal 100 may be a user equipment (UE), a mobile phone, a laptop, a tablet computer, an electronic book or a portable computer system and is not limited herein. The wireless terminal 100 may include a processor 1000 such as a microprocessor or Application Specific Integrated Circuit (ASIC), a storage unit 1010 and a communication unit 1020. The storage unit 1010 may be any data storage device that stores a program code 1012, which is accessed and executed by the processor 1000. Embodiments of the storage unit 1010 include but are not limited to a subscriber identity module (SIM), read-only memory (ROM), flash memory, random-access memory (RAM), hard-disk, and optical data storage device. The communication unit 1020 may a transceiver and is used to transmit and receive signals (e.g., messages or packets) according to processing results of the processor 1000. In an embodiment, the communication unit 1020 transmits and receives the signals via at least one antenna 1022 shown in FIG. 10.

In an embodiment, the storage unit 1010 and the program code 1012 may be omitted and the processor 1000 may include a storage unit with stored program code.

The processor 1000 may implement any one of the steps in exemplified embodiments on the wireless terminal 100, e.g., by executing the program code 1012.

The communication unit 1020 may be a transceiver. The communication unit 1020 may as an alternative or in addition be combining a transmitting unit and a receiving unit configured to transmit and to receive, respectively, signals to and from a wireless network node (e.g., a base station).

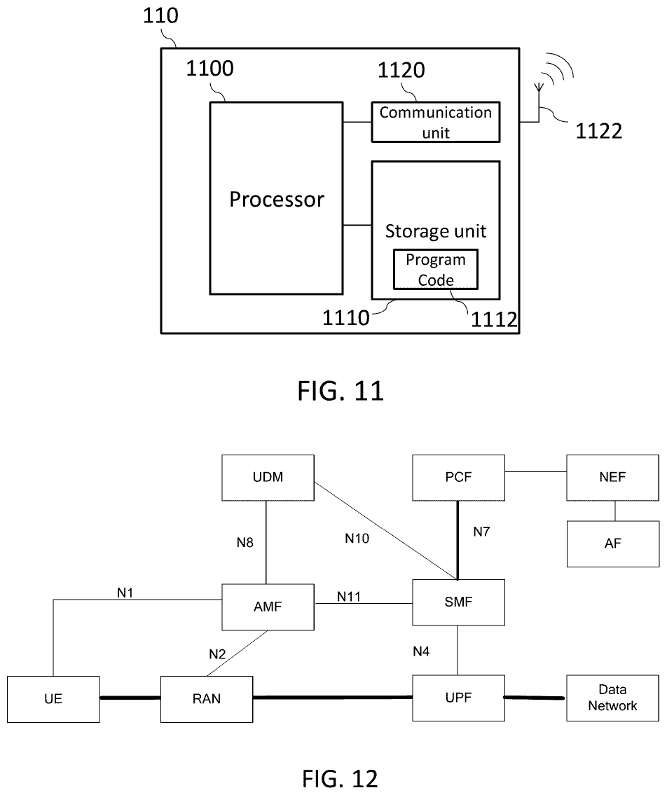

FIG. 11 relates to a schematic diagram of a wireless network node 110 according to an embodiment of the present disclosure. The wireless network node 110 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 110 may comprise (perform) at least one network function such as an access and mobility management function (AMF), a session management function (SMF), a user place function (UPF), a policy control function (PCF), an application function (AF), etc. The wireless network node 110 may include a processor 1100 such as a microprocessor or ASIC, a storage unit 1110 and a communication unit 1120. The storage unit 1110 may be any data storage device that stores a program code 1112, which is accessed and executed by the processor 1100. Examples of the storage unit 1110 include but are not limited to a SIM, ROM, flash memory, RAM, hard-disk, and optical data storage device. The communication unit 1120 may be a transceiver and is used to transmit and receive signals (e.g., messages or packets) according to processing results of the processor 1100. In an example, the communication unit 1120 transmits and receives the signals via at least one antenna 1122 shown in FIG. 11.

In an embodiment, the storage unit 1110 and the program code 1112 may be omitted. The processor 1100 may include a storage unit with stored program code.

The processor 1100 may implement any steps described in exemplified embodiments on the wireless network node 110, e.g., via executing the program code 1112.

The communication unit 1120 may be a transceiver. The communication unit 1120 may as an alternative or in addition be combining a transmitting unit and a receiving unit configured to transmit and to receive, respectively, signals to and from a wireless terminal (e.g., a user equipment or another wireless network node).

FIG. 12 shows a schematic diagram of a network (architecture) according to an embodiment of the present disclosure. In FIG. 1, the network comprises the following network functions/entities:
1) UE: User Equipment
2) RAN: Radio Access Network

In the present disclosure, the RAN may be equal to RAN node or next-generation RAN (NG-RAN) (node).
3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.
4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from AMF.
5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QOS) handling for the UP, downlink packet buffering and downlink data notification triggering, etc.
6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which is used for AMF to select a proper SMF. The AMF and SMF get the subscription from UDM. The subscription data is stored in the Unified Data Repository (UDR). The UDM uses such data upon reception of request from AMF or SMF.
7) PCF: Policy Control Function

The PCF supports unified policy framework to govern network behavior. The PCF provides access management policy to the AMF, or session management policy to the SMF, and/or UE policy to the UE. The PCF can access the UDR to obtain subscription information relevant for policy decisions. The PCF may also generate the policy to govern network behavior based on the subscription and indication from an application function (AF). Then, the PCF can provide policy rules to CP functions (e.g., the AMF and/or the SMF) to enforce the CP functions.
8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.
9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the wireless communication method comprising:
receiving, from a wireless network node, a system information block of an anchor cell, wherein the system information block of the anchor cell comprises a radio resource configuration for at least one non-anchor cell,
selecting the anchor cell or one of the at least one non-anchor cell based on the radio resource configuration, and
performing a random access procedure in the selected cell.

2. The wireless communication method of claim 1, wherein the radio resource configuration for a first non-anchor cell in the at least one non-anchor cell comprises at least one of:
a physical cell identity of the first non-anchor cell,
uplink frequency information of the first non-anchor cell,
downlink frequency information of the first non-anchor cell,
a physical random access channel (PRACH) resource configuration of the first non-anchor cell,
a common search space configuration of the first non-anchor cell,
a reference signal received power (RSRP) threshold of the first non-anchor cell,
a weight or an indication for a random access process on the first non-anchor cell, or
at least one downlink reference signal of the first non-anchor cell.

3. The wireless communication method of claim 1, wherein the anchor cell and a first non-anchor cell of the at least one non-anchor cell have a same physical cell identity if the radio resource configuration does not comprise a physical cell identity of the first non-anchor cell.

4. The wireless communication method of claim 1, wherein a first non-anchor cell in the at least one non-anchor cell shares at least one downlink reference signal with the anchor cell or a second non-anchor cell in the at least one non-anchor cell.

5. The wireless communication method of claim 1, wherein selecting the anchor cell or one of the at least one non-anchor cell based on the radio resource configuration comprises:
selecting the anchor cell or one of the at least one non-anchor cell based on a weight of each of the anchor cell and the at least one non-anchor cell for the random access procedure.

6. The wireless communication method of claim 1, wherein selecting the anchor cell or one of the at least one non-anchor cell based on the radio resource configuration comprises:
selecting the anchor cell or the at least one non-anchor cell based on at least one of a first weight of the anchor cell for the random access procedure or a second weight of the at least one non-anchor cell for the random access procedure, and
selecting one of the at least one non-anchor cell if the at least one non-anchor cell is selected.

7. The wireless communication method of claim 1, wherein the radio resource configuration comprises an indication of performing the random access procedure on the non-anchor cell, and
wherein selecting the anchor cell or one of the at least one non-anchor cell based on the radio resource configuration comprises:
selecting one of the at least one non-anchor cell.

8. The wireless communication method of claim 1, wherein the radio resource configuration comprises an indication of performing the random access procedure on the anchor cell or the non-anchor cell, and
wherein selecting the anchor cell or one of the at least one non-anchor cell based on the radio resource configuration comprises:
selecting the anchor cell or one of the at least one non-anchor cell.

9. The wireless communication method of claim 5, wherein a reference signal received power of the selected cell is greater than or equal to a reference signal received power threshold of the selected cell.

10. The wireless communication method of claim 1, wherein performing the random access procedure on the selected cell comprises:
transmitting, to the wireless network node in the selected cell, candidate cell information associated with at least one candidate cell,
receiving, from the wireless network node in the selected cell, mobility information associated with one of the at least one candidate cell, and
transmitting, to the wireless network node in the candidate cell associated with the mobility information, a radio resource control response message.

11. The wireless communication method of claim 10, wherein the candidate cell information associated with the at least one candidate cell is included in a Message 3 of the random access procedure.

12. The wireless communication method of claim 10, further comprising:
transmitting, to the wireless network node, a Message 3 of the random access procedure in the selected cell, and
receiving, from the wireless network node, a report indication for the candidate cell information.

13. The wireless communication method of claim 10, further comprising:
handing over to the candidate cell associated with the mobility information, or
adding the candidate cell associated with the mobility information as a secondary cell for a carrier aggregation or a dual connectivity.

14. The wireless communication method of claim 10, further comprising:
receiving, from the wireless network node in the candidate cell associated with the mobility information, system information for a radio resource control connected state.

15. The wireless communication method of claim 1, wherein performing the random access procedure in the selected cell comprises:
transmitting, to the wireless network node in the selected cell, a capability indication of supporting the random access procedure in the non-anchor cell.

16. The wireless communication method of claim 15, wherein the capability indication is included in a Message 3, a Message 5 of the random access procedure, a user equipment capability information message or an uplink media access control control element.

17. The wireless communication method of claim 15, wherein performing the random access procedure in the selected cell further comprises:
receiving, from the wireless network node, a preamble configuration of a third non-anchor cell in the at least one non-anchor cell by downlink configuration information or a radio resource control message, and
transmitting, to the wireless network node in the third non-anchor cell, a random access preamble based on the preamble configuration,
wherein the preamble configuration includes at least one of a cell identity of the third non-anchor cell, uplink frequency information of the third non-anchor cell or a preamble index.

18. A wireless terminal, comprising:
a communication unit, configured to receive, from a wireless network node, a system information block of an anchor cell, wherein the system information block of the anchor cell comprises a radio resource configuration for at least one non-anchor cell, and
at least one processor configured to:
select the anchor cell or one of the at least one non-anchor cell based on the radio resource configuration, and
perform a random access procedure in the selected cell.

19. A non-transitory computer-readable program medium with code stored thereupon, the code, when executed by at least one processor, causes the at least one processor to implement the wireless communication method recited in claim 1.
